(19) United States
(12) Patent Application Publication
(10) Pub. No.: US 2022/0277719 A1
(43) Pub. Date: Sep. 1, 2022

(54) MUSICAL INSTRUMENT PLAYING APPARATUS AND MUSICAL KEYBOARD INSTRUMENT

(71) Applicant: YAMAHA CORPORATION, Hamamatsu-shi (JP)

(72) Inventor: Jun ISHII, Hamamatsu-shi (JP)

(21) Appl. No.: 17/747,301

(22) Filed: May 18, 2022

Related U.S. Application Data
(63) Continuation of application No. PCT/JP2020/041321, filed on Nov. 5, 2020.

(30) Foreign Application Priority Data
Nov. 20, 2019 (JP) 2019-209535

(51) Int. Cl. G10H 1/34; G10H 1/00

(52) U.S. Cl. CPC G10H 1/344; G10H 1/0008; G10H 2220/221; G10H 2220/275

(57) ABSTRACT

A musical keyboard instrument includes a key displaceable in response to a playing operation, a detection system including a magnetic body disposed on or in the key, and a coil facing and spaced from the magnetic body and configured to generate a magnetic field in response to receiving a supply of current, wherein the detection system is configured to generate a detection signal with a level that depends on a distance between the magnetic body and the coil, and an electromagnetic shield configured to block electromagnetic waves emitted from the detection system.

### CROSS REFERENCE TO RELATED APPLICATIONS

This application is a Continuation application of PCT Application No. PCT/JP2020/041321, filed Nov. 5, 2020, and is based on, and claims priority from, Japanese Patent Application No. 2019-209535, filed Nov. 20, 2019, the entire contents of which are incorporated herein by reference.

### BACKGROUND

### Technical Field

The present disclosure relates to a musical instrument playing apparatus for use in musical play.

### Background Information

There have been conventionally proposed a variety of techniques for detecting displacement of a movable member, such as a key of a musical keyboard instrument, for example. U.S. Pat. No. 4,580,478 discloses a configuration in which a first coil disposed on a frame of a musical keyboard instrument and a second coil disposed on each key are used to detect a position of each key. In the above configuration, when the second coil is displaced on depression of the key, a current flowing through the first coil changes. Based on detection of current flowing through the first coil, a detection signal is generated that indicates whether the key is depressed.

However, the technique disclosed in U.S. Pat. No. 4,580,478 has a problem in that electromagnetic waves, due to current flowing to each coil, can affect other electronic devices around the musical keyboard instrument.

### SUMMARY

In view of the circumstances described above, an object of one aspect of the present disclosure is to realize countermeasures against electromagnetic interference (EMI) in a system for detecting a position of a movable member such as a key.

In one aspect, a musical instrument playing apparatus includes a movable member displaceable in response to a playing operation, a detection system including a magnetic body disposed on or in the movable member and a coil facing and spaced from the magnetic body and configured to generate a magnetic field in response to receiving a supply of current, wherein the detection system is configured to generate a detection signal with a level that depends on a distance between the magnetic body and the coil, and an electromagnetic shield configured to block electromagnetic waves emitted from the detection system.

In another aspect, a musical keyboard instrument includes a key displaceable in response to a playing operation, a detection system including a magnetic body disposed on or in the key and a coil facing and spaced from the magnetic body and configured to generate a magnetic field in response to receiving a supply of current, wherein the detection system is configured to generate a detection signal with a level that depends on a distance between the magnetic body and the coil, an electromagnetic shield configured to block electromagnetic waves emitted from the detection system, and a sound generator configured to generate sound in accordance with the detection signal.

### BRIEF DESCRIPTION OF THE DRAWINGS

FIG. 1 is a block diagram showing a configuration of a musical keyboard instrument in a first embodiment.

FIG. 2 is a block diagram showing the configuration of the musical keyboard instrument.

FIG. 3 is a circuit diagram of a signal generator.

FIG. 4 is a circuit diagram of a detectable portion.

FIG. 5 is a block diagram showing a configuration of a signal processing circuit.

FIG. 6 is a plan view of keys viewed from the signal generator.

FIG. 7 is a plan view showing a configuration of the detectable portion.

FIG. 8 is a cross section taken along line a-a in FIG. 7.

FIG. 9 is an explanatory diagram of a magnetic field generated by a first coil of the detectable portion.

FIG. 10 is a plan view of signal generators viewed from the keys.

FIG. 11 is a plan view showing a configuration of the signal generator.

FIG. 12 is a cross section taken along line b-b in FIG. 10.

FIG. 13 is an explanatory diagram of a magnetic field generated by a second coil of the signal generator.

FIG. 14 is a plan view of signal generators in a second embodiment.

FIG. 15 is a cross section taken along line c-c in FIG. 14.

FIG. 16 is a plan view of a second shield in the second embodiment.

FIG. 17 is a plan view of the second shield in a modification of the second embodiment.

FIG. 18 is a plan view showing the detectable portion in a third embodiment.

FIG. 19 is a cross section taken along line d-d in FIG. 18.

FIG. 20 is a plan view of the first shield in the third embodiment.

FIG. 21 is a cross section of the signal generator in a fourth embodiment.

FIG. 22 is a cross section of the detectable portion in a fifth embodiment.

FIG. 23 is a schematic view of a detection system in a sixth embodiment.

FIG. 24 is a schematic view of a detection system in a seventh embodiment.

FIG. 25 is a schematic view of a detection system in an eighth embodiment.

FIG. 26 is a cross section of the first shield according to a modification.

### DESCRIPTION OF THE EMBODIMENTS

### A: First Embodiment

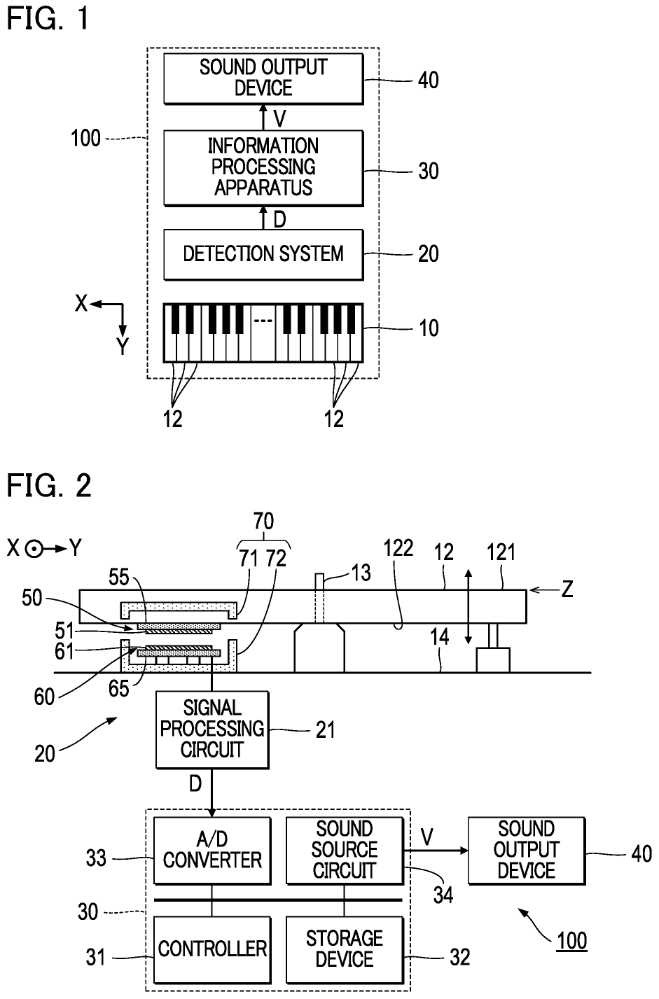

FIG. 1 is a block diagram showing a configuration of a musical keyboard instrument 100 in a first embodiment of the present disclosure. The musical keyboard instrument 100 (an example of a “musical instrument playing apparatus”) is an electronic musical instrument including a keyboard 10, a detection system 20, an information processing apparatus 30, and a sound output device 40. The keyboard 10 includes a plurality of keys 12 (an example of a “plurality of movable members”) including a plurality of white keys and a plurality of black keys. Each of the plurality of keys 12 is a movable member that is displaceable in response to a playing operation by a user. The detection system 20 detects a position of each key 12. The information processing apparatus 30 generates an audio signal V in accordance with a result of a detection by the detection system 20. The audio signal V is a signal representative of a musical sound with a pitch that corresponds to one of the keys 12 operated by a user. The sound output device 40 outputs sound represented by the audio signal V. For example, headphones or an audio speaker is used as the sound output device 40.

FIG. 2 is a block diagram showing a configuration of the musical keyboard instrument 100, focusing on one of the keys 12 of the keyboard 10. An X-axis and a Y-axis are defined. The plurality of keys 12 are aligned along the X-axis. The Y-axis is perpendicular to the X-axis. An X-Y plane is a horizontal plane. Each key 12 is arranged such that the longitudinal direction of the key 12 is along the Y-axis. In other words, the Y-axis is an axis line along a long side of each key 12. A view from a direction perpendicular to the X-Y plane is referred to as a “plan view” in the following.

Each key 12 of the keyboard 10 is supported by a support 14 using a fulcrum body (a balance pin) 13 as a fulcrum. The support 14 is a structure (frame) supporting each element of the musical keyboard instrument 100. Each key 12 has an end 121 that is displaceable in a vertical direction in response to depression of the key by a user and in response to release of the key by a user. The detection system 20 generates a detection signal D having a level depending on a vertical position Z of the end 121 for each of the keys 12. The position Z is represented by an amount of displacement of the end 121 from a position of the end 121 in a release state in which no load is applied to the key 12.

The detection system 20 includes a detectable portion 50, a signal generator 60, a substructure 65, and a signal processing circuit 21. The detectable portion 50 and the signal generator 60 are disposed for each key 12. The signal generator 60 is disposed on the support 14. The detectable portion 50 is disposed on the key 12. Specifically, the detectable portion 50 is disposed on a bottom surface (hereinafter referred to as an “installation surface”) 122 of the key 12. The detectable portion 50 includes a first coil 51 (an example of a “magnetic body”). The signal generator 60 includes a second coil 61 (an example of a “coil”). The first coil 51 and the second coil 61 face each other with a space in a vertical direction. A distance between the signal generator 60 and the detectable portion 50 (a distance between the first coil 51 and the second coil 61) varies depending on the position Z of the end 121 of the key 12.

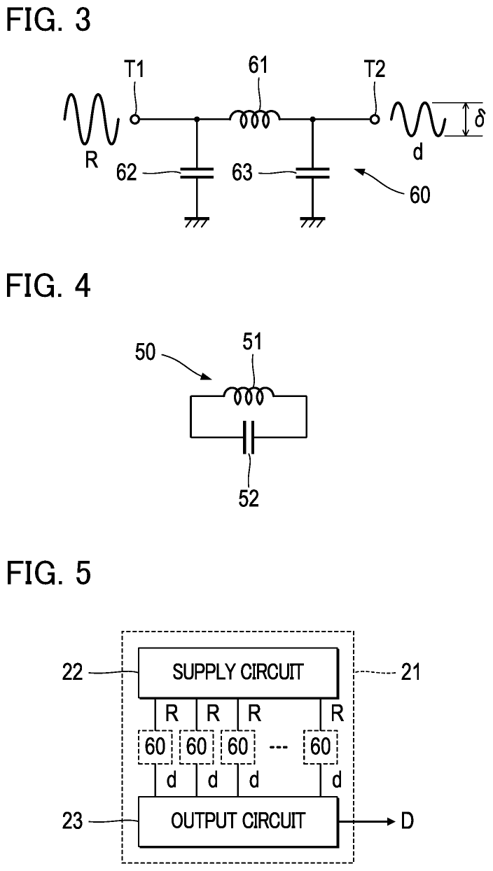

FIG. 3 is a circuit diagram showing an electrical configuration of the signal generator 60. The signal generator 60 includes a resonant circuit including an input terminal T1, an output terminal T2, the second coil 61, a capacitive element 62, and a capacitive element 63. The second coil 61 is connected between the input terminal T1 and the output terminal T2. The capacitive element 62 is connected between the input terminal T1 and a ground line, and the capacitive element 63 is connected between the output terminal T2 and the ground line. The signal generator 60 functions as a low-cut filter to attenuate low frequency components in a signal supplied to the input terminal T1.

FIG. 4 is a circuit diagram showing an electrical configuration of the detectable portion 50. The detectable portion 50 includes a resonance circuit including the first coil 51 and a capacitive element 52. One end of the first coil 51 is connected to one end of capacitive element 52, and the other end of the first coil 51 is connected to the other end of capacitive element 52. The resonant frequency of the detectable portion 50 and the resonant frequency of the signal generator 60 are the same. However, the resonant frequency of the detectable portion 50 and the resonant frequency of the signal generator 60 may differ from each other.

The signal processing circuit 21 in FIG. 2 generates the detection signal D having a level depending on a distance between the first coil 51 and the second coil 61. FIG. 5 is a block diagram showing a functional configuration of the signal processing circuit 21. The signal processing circuit 21 includes a supply circuit 22 and an output circuit 23. The supply circuit 22 supplies a reference signal R to each of a plurality of signal generators 60. The reference signal R is a current signal or a voltage signal of which the level fluctuates periodically. For example, a periodic signal having a freely selected waveform such as a sine wave may be used as the reference signal R. The supply circuit 22 supplies the reference signal R to each signal generator 60 in a time-shared manner. Specifically, the supply circuit 22 is a demultiplexer that sequentially selects each of the plurality of signal generators 60 to supply the reference signal R to the selected signal generator 60. In other words, the reference signal R is supplied to each of the plurality of signal generators 60 in a time-shared manner. The period of the reference signal R is sufficiently shorter than the duration of a period in which the supply circuit 22 is selecting one of the signal generators 60. The frequency of the reference signal R is approximately equal to the resonance frequency of each of the signal generator 60 and the detectable portion 50. However, the frequency of the reference signal R and the resonance frequency of each of the signal generator 60 and the detectable portion 50 may differ from each other.

As shown in FIG. 3, the reference signal R is supplied to the input terminal T1 of the signal generator 60. In response to a current, which depends on the reference signal R, being supplied to the second coil 61, a magnetic field is generated by the second coil 61. In response to electromagnetic induction due to the magnetic field generated by the second coil 61, an induced current is generated in the first coil 51. Therefore, a magnetic field, which cancels out a change in the magnetic field generated by the second coil 61, is generated by the first coil 51. The magnetic field generated by the first coil 51 varies in accordance with the distance between the first coil 51 and the second coil 61. Therefore, a detection signal d having an amplitude level δ depending on the distance between the first coil 51 and the second coil 61 is output from the output terminal T2 of the signal generator 60. The detection signal d is a periodic signal of which the level fluctuates with the same period as the reference signal R.

The output circuit 23 in FIG. 5 generates the detection signal D by aligning the respective detection signal d, which is sequentially output from each of the plurality of signal generators 60, on a time axis. In other words, the detection signal D is a voltage signal having the amplitude level δ depending on the distance between the first coil 51 and the second coil 61 for each key 12. As described above, since the distance between the first coil 51 and the second coil 61 is linked to the position Z of each key 12, the detection signal D is represented as a signal depending on the position Z of each of the plurality of keys 12. The detection signal D generated by the output circuit 23 is supplied to the information processing apparatus 30.

The information processing apparatus 30 in FIG. 2 analyzes the detection signal D supplied from the signal processing circuit 21 to analyze the position Z of each key 12. The information processing apparatus 30 is realized by a computer system including a controller 31, a storage device 32, an A/D converter 33 and a sound source circuit 34. The A/D converter 33 converts the detection signal D, which is supplied from the signal processing circuit 21, from an analog signal to a digital signal.

The controller 31 includes one or more processors that control each of elements of the musical keyboard instrument 100. For example, the controller 31 is constituted of one or more types, among different types, such as a Central Processing Unit (CPU), a Sound Processing Unit (SPU), a Digital Signal Processor (DSP), a Field Programmable Gate Array (FPGA), and an Application Specific Integrated Circuit (ASIC).

The storage device 32 includes one or more memories that store programs executed by the controller 31 and data used by the controller 31. The storage device 32 is constituted of, for example, a known recording medium, such as a magnetic recording medium or a semiconductor recording medium. The storage device 32 may include a combination of different types of recording media. The storage device 32 may be a portable recording medium detachable from the musical keyboard instrument 100, or the storage device 32 may be an external recording medium (for example, online storage), with which the musical keyboard instrument 100 can communicate.

The controller 31 analyzes the detection signal D after conversion by the A/D converter 33 to analyze the position Z of each key 12. Furthermore, the controller 31 instructs the sound source circuit 34 to produce a musical sound based on the position Z of each key 12. The sound source circuit 34 generates the audio signal V representative of the musical sound as instructed by the controller 31. In other words, the sound source circuit 34 generates the audio signal V in accordance with the amplitude levels 6 of the detection signal D. For example, the volume of the audio signal V is controlled in accordance with the amplitude levels 6. The audio signal V is supplied from the sound source circuit 34 to the sound output device 40, whereby a musical sound that accords with playing operations performed by a user (depression or release of each key 12) is output from the sound output device 40. The controller 31 may realize the functions of the sound source circuit 34 by executing the program stored in the storage device 32.

The detection system 20 emits electromagnetic waves due to both the magnetic field generated by the first coil 51 and the magnetic field generated by the second coil 61. An electromagnetic shield 70 in FIG. 2 is used to prevent electromagnetic interference (EMI), in which electromagnetic waves emitted from the detection system 20 affect other electronic devices in the surrounding area. Specifically, the electromagnetic shield 70 is a barrier for blocking the electromagnetic waves emitted from the detection system 20. The electromagnetic shield 70 is formed of a magnetic or a conductive material. For example, the electromagnetic shield 70 may be formed of metal.

Specifically, the electromagnetic shield 70 is formed to surround the detection system 20. The electromagnetic shield 70 according to the first embodiment includes a first shield 71 and a second shield 72. The first shield 71 is a barrier for blocking electromagnetic waves emitted from the detectable portion 50. On the other hand, the second shield 72 is a barrier for blocking electromagnetic waves emitted from the signal generators 60. The first shield 71 is disposed on the key 12, and the second shield 72 is disposed on the support 14. An example of a configuration of each of the first shield 71 and the second shield 72 will be described later.

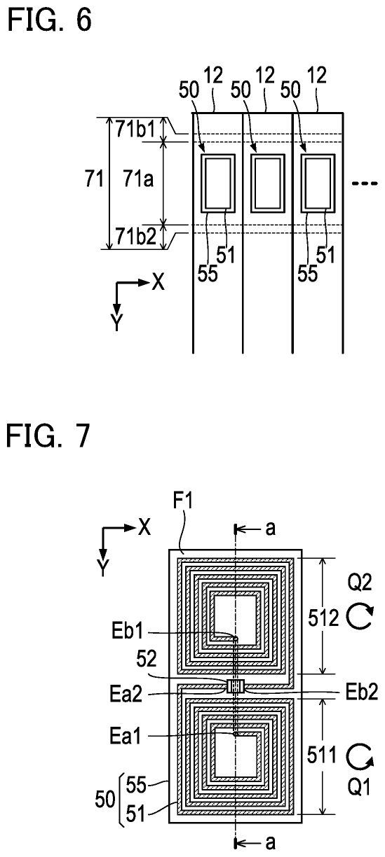

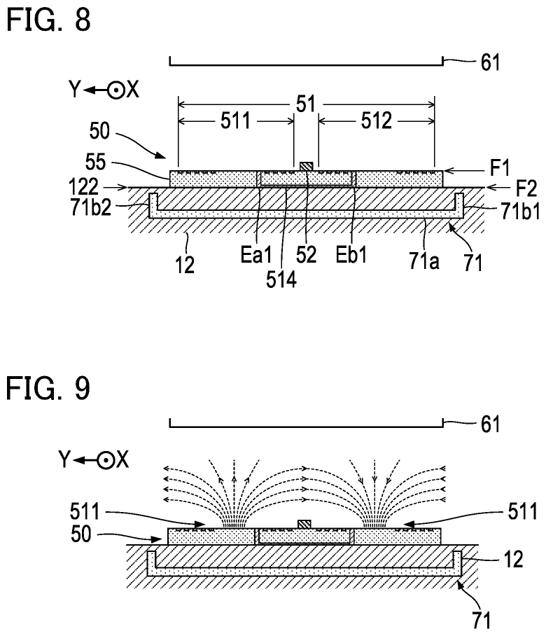

FIG. 6 is a plan view of the keys 12 viewed from the signal generators 60. The detectable portion 50 is disposed on each key 12. The first shield 71 is disposed for each detectable portion 50 (first coil 51). FIG. 7 is a plan view showing a configuration of the detectable portion 50. FIG. 7 is the plan view of the detectable portion 50 viewed from the signal generator 60. FIG. 8 is a cross section taken along line a-a in FIG. 7.

The detectable portion 50 according to the first embodiment is constituted of a wiring substrate including the first coil 51 and a substructure 55. The substructure 55 is a rectangular plate-shaped member including a surface F1 and a surface F2. The surface F2 is a surface facing the installation surface 122 of the key 12. The surface F1 is a surface opposite to the surface F2. Therefore, the surface F1 faces the signal generator 60. The width of the substructure 55 is less than the width of the key 12.

The first coil 51 is a conductive film formed on the surfaces (the surface F1 and the surface F2) of the substructure 55. Specifically, the first coil 51 is formed by a patterning process in which the conductive film covering the entire surfaces of the substructure 55 is selectively removed. The first coil 51 includes a first section 511 and a second section 512. The first section 511 and the second section 512 are formed on the surface F1. The first section 511 and the second section 512 are formed in different areas in plan view viewed from a direction perpendicular to the surface F1. Specifically, the first section 511 and the second section 512 are adjacent to each other along the longitudinal direction (Y-axis) of the key 12.

The first section 511 is a clockwise spiral portion from an inner end Ea1 to an outer end Ea2. On the other hand, the second section 512 is a clockwise spiral portion from an inner end Eb1 to an outer end Eb2.

The first coil 51 includes a connecting wiring 514 formed on the surface F2 of the substructure 55. The end Ea1 and the end Eb1 are interconnected via the connecting wiring 514. The capacitive element 52 mounted on the surface F1 is interposed between the end Ea2 and the end Eb2.

As will be understood from the above description, a direction of current flowing through the first section 511 and a direction of current flowing through the second section 512 are opposite to each other. Specifically, in a situation in which a current flows through the first section 511 in a direction Q1, a current flows through the second section 512 in a direction Q2 opposite to the direction Q1. Therefore, as shown in FIG. 9, the direction of a magnetic field generated by the first section 511 is opposite to the direction of a magnetic field generated by the second section 512. In other words, a magnetic field from one of the first section 511 and the second section 512 toward the other is formed.

As shown in FIG. 8, the first shield 71 according to the first embodiment is embedded in the key 12. The first shield 71 is formed so as to overlap the first coil 51 in plan view. Specifically, the first shield 71 includes a first base 71a, a first sidewall 71b1, and a first sidewall 71b2. The first base 71a is a portion apart from the first coil 51 in a direction opposite to a direction from the first coil 51 toward the second coil 61. In other words, the first coil 51 is positioned between the second coil 61 and the first base 71a. Specifically, the first base 71a is a plate-shaped member parallel to the substructure 55. As shown in FIG. 6, the first coil 51 is positioned inside the first base 71a in plan view. The first base 71a is formed, for example, over the entire key 12 in a lateral direction (in a direction of the X-axis).

As shown in FIG. 8, the first sidewall 71b1 and the first sidewall 71b2 are each a portion protruding from the first base 71a toward the support 14. In other words, the first sidewall 71b1 and the first sidewall 71b2 each are formed from the surface of the first base 71a toward the installation surface 122. The first sidewall 71b1 and the first sidewall 71b2 are formed on peripheral edges along the X-axis among peripheral edges of the first base 71a. The first sidewall 71b1 is formed on a peripheral edge positioned in a negative direction of the Y-axis among the peripheral edges of the first base 71a along the X-axis. The first sidewall 71b2 is formed on a peripheral edge positioned in a positive direction of the Y-axis among the peripheral edges of the first base 71a along the X-axis. As shown in FIG. 6, the first coil 51 is positioned between the first sidewall 71b1 and the first sidewall 71b2. One or both of the first sidewall 71b1 and the first sidewall 71b2 may be omitted.

The electromagnetic waves emitted from the first coil 51 are blocked by the first shield 71. In the first embodiment, since the first shield 71 includes the first base 71a, the first shield 71 can effectively block the electromagnetic waves emitted from the magnetic body in a direction opposite to a direction from the magnetic body toward the coil, as shown in FIG. 9. Furthermore, since the first shield 71 includes the first sidewall 71b1 and the first sidewall 71b2, there is an advantage of effectively blocking the electromagnetic waves emitted from the first coil 51 toward the surroundings.

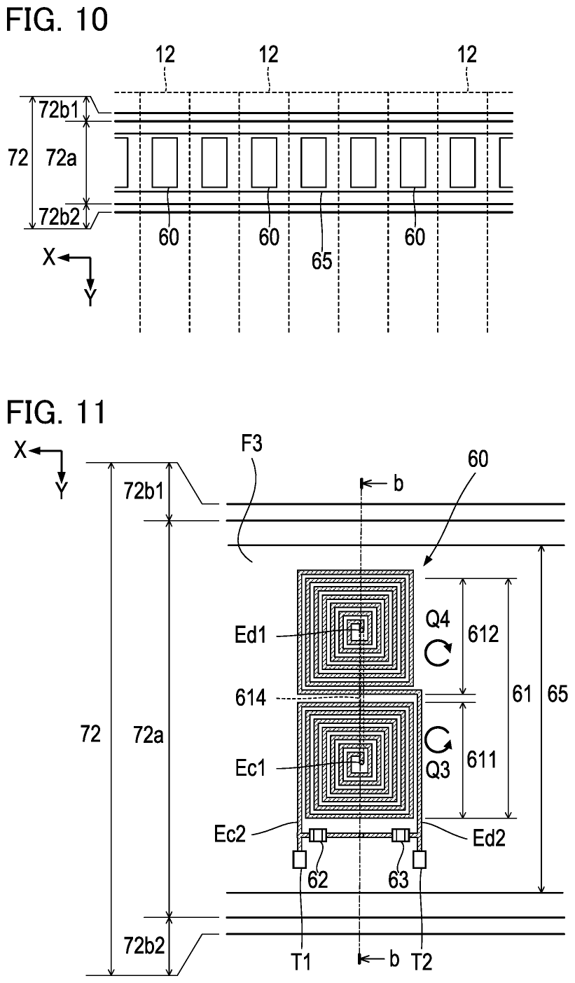

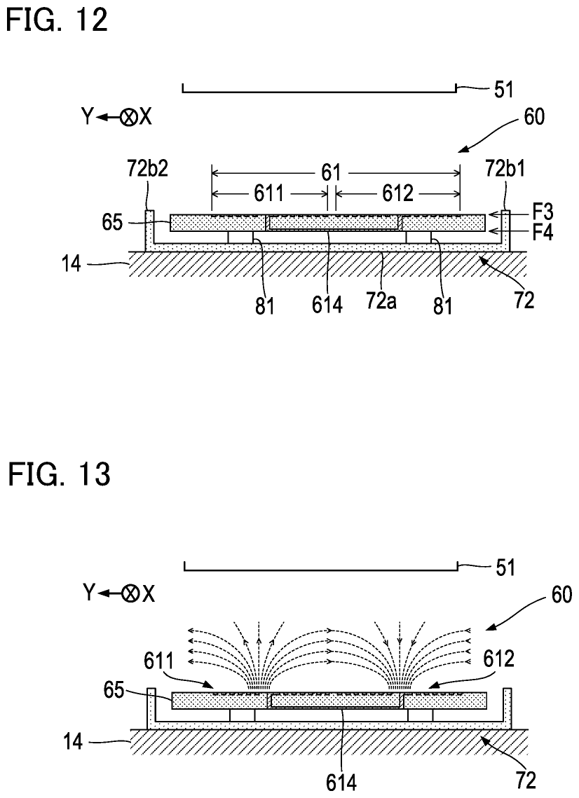

FIG. 10 is a plan view of the signal generators 60 viewed from the keys 12. The second coil 61 is disposed for each first coil 51. The second shield 72 according to the first embodiment is disposed over the plurality of keys 12. In other words, the second shield 72 is formed in a long shape along the X-axis. FIG. 11 is a plan view showing a configuration of the signal generator 60. FIG. 11 is the plan view of the signal generator 60 viewed from the detectable portion 50. FIG. 12 is a cross section taken along line b-b in FIG. 11.

As shown in FIG. 11, the signal generator 60 is constituted of a wiring substrate including the second coil 61. The signal generator 60 is formed on the substructure 65. The substructure 65 is a long, plate-shaped member over the plurality of keys 12. As shown in FIG. 12, the substructure 65 is the plate-shaped member including a surface F3 and a surface F4. The surface F4 faces a second base 72a. The surface F3 is a surface opposite to the surface F4. Therefore, the surface F3 faces the detectable portion 50. The substructure 65 may be disposed for each key 12.

As shown in FIG. 11, the second coil 61 is a conductive film formed on the surfaces (the surface F3 and the surface F4) of the substructure 65. Specifically, a plurality of second coils 61 are formed together by a patterning process in which the conductive film covering the entire surfaces of the substructure 65 is selectively removed. The plurality of second coils 61 corresponding to the different keys 12 are formed on the substructure 65. Specifically, the second coil 61 includes a third section 611 and a fourth section 612. The third section 611 and the fourth section 612 are formed on the surface F3. The third section 611 and the fourth section 612 are formed in different areas in plan view viewed from a direction perpendicular to the surface F3. Specifically, the third section 611 and the fourth section 612 are adjacent to each other along the longitudinal direction of the key 12.

The third section 611 is a counterclockwise spiral portion from an inner end Ec1 to an outer end Ec2. On the other hand, the fourth section 612 is a counterclockwise spiral portion from an inner end Ed1 to an outer end Ed2. The distance between the first coil 51 and the second coil 61 in a direction of a central axis of the second coil 61 (that is, the direction perpendicular to the surface F3) varies in accordance with the position Z of the key 12.

The second coil 61 includes a connecting wiring 614 formed on the surface F4 of the substructure 65. The end Ec1 and the end Ed1 are interconnected via the connecting wiring 614. The input terminal T1 and the output terminal T2 are formed on the surface F3. The capacitive element 62 is connected between the input terminal T1 and the end Ec2 of the third section 611. The capacitive element 63 is connected between the output terminal T2 and the end Ed2 of the fourth section 612. A wiring connecting the capacitive element 62 with the capacitive element 63 is connected to a ground point G that is set to a ground potential.

As will be understood from the above description, a direction of a current flowing through the third section 611 and a direction of a current flowing through the fourth section 612 are opposite to each other. Specifically, in a situation in which a current flows through the third section 611 in a direction Q3, a current flows through the fourth section 612 in a direction Q4 opposite to the direction Q3. Therefore, as shown in FIG. 13, a direction of a magnetic field generated by the third section 611 is opposite to a direction of a magnetic field generated by the fourth section 612. In other words, a magnetic field from one of the third section 611 and the fourth section 612 toward the other is formed.

As shown in FIG. 12, the second shield 72 is disposed on the surface of the support 14. Specifically, the second shield 72 is disposed on an area overlapping the plurality of second coils 61 in plan view. The second shield 72 according to the first embodiment includes the second base 72a, a second sidewall 72b1, and a second sidewall 72b2. The second base 72a is a portion apart from the second coil 61 in a direction opposite to a direction from the second coil 61 toward the first coil 51. In other words, the second coil 61 is positioned between the first coil 51 and the second base 72a. As shown in FIG. 10, the second base 72a according to the first embodiment is a plate-shaped member that is long along the X-axis. For example, the second base 72a extends from one end of the keyboard 10 to the other end. The second base 72a is disposed on the surface of the support 14.

As shown in FIG. 12, the second sidewall 72b is a portion protruding from the second base 72a toward the key 12. The second sidewall 72b1 and the second sidewall 72b2 are formed on peripheral edges along the X-axis among peripheral edges of the second base 72a. The second sidewall 72b1 is formed on a peripheral edge positioned in the negative direction of the Y-axis among the peripheral edges of the second base 72a along the X-axis. The second sidewall 72b2 is formed on a peripheral edge positioned in the positive direction of the Y-axis among the peripheral edges of the second base 72a along the X-axis. As shown in FIG. 10, the signal generators 60 (the second coils 61) are positioned between the second sidewall 72b1 and the second sidewall 72b2. One or both of the second sidewall 72b1 and the second sidewall 72b2 may be omitted.

As shown in FIG. 12, the substructure 65, on which the signal generators 60 are formed, is disposed in a space surrounded by the second base 72a, the second sidewall 72b1, and the second sidewall 72b2. The substructure 65 according to the first embodiment is supported by the second shield 72. Specifically, the substructure 65 is supported with fixing members 81 disposed on the surface of the second base 72a. The fixing members 81 are each, for example, a spacer that is formed of insulating material. The spacer holds the substructure 65 spaced apart from the second base 72a. In other words, the substructure 65 and the second shield 72 are not in direct contact with each other.

The electromagnetic waves emitted from the second coil 61 are blocked by the second shield 72. In the first embodiment, the second shield 72 can effectively block the electromagnetic waves emitted from the second coil 61 in a direction opposite to a direction from the second coil 61 toward the first coil 51. Furthermore, since the second shield 72 includes the second sidewall 72b1 and the second sidewall 72b2, there is an advantage of effectively blocking the electromagnetic waves emitted from the second coil 61 toward the surroundings. For example, the electromagnetic waves emitted from the second coil 61 in a direction of the Y-axis can be blocked by the second sidewall 72b1 and the second sidewall 72b2.

As will be understood from the above description, in the first embodiment, countermeasures against EMI are realized by the electromagnetic shield 70 for blocking the electromagnetic waves emitted from the detection system 20 including the first coil 51 and the second coil 61. Therefore, it is possible to reduce effects of electromagnetic waves emitted from the detection system 20 on surrounding electronic devices. In the first embodiment since the electromagnetic shield 70 includes the first shield 71 disposed on the key 12 and the second shield 72 disposed on the support 14, effective countermeasures against EMI are realized compared to a configuration in which the electromagnetic shield 70 is disposed on either the support 14 or the key 12.

### B: Second Embodiment

A second embodiment will be described below. In each example shown below, elements having functions identical to those in the first embodiment are denoted by like reference signs as used in the descriptions in the first embodiment, and detailed explanations of such elements are omitted, as appropriate.

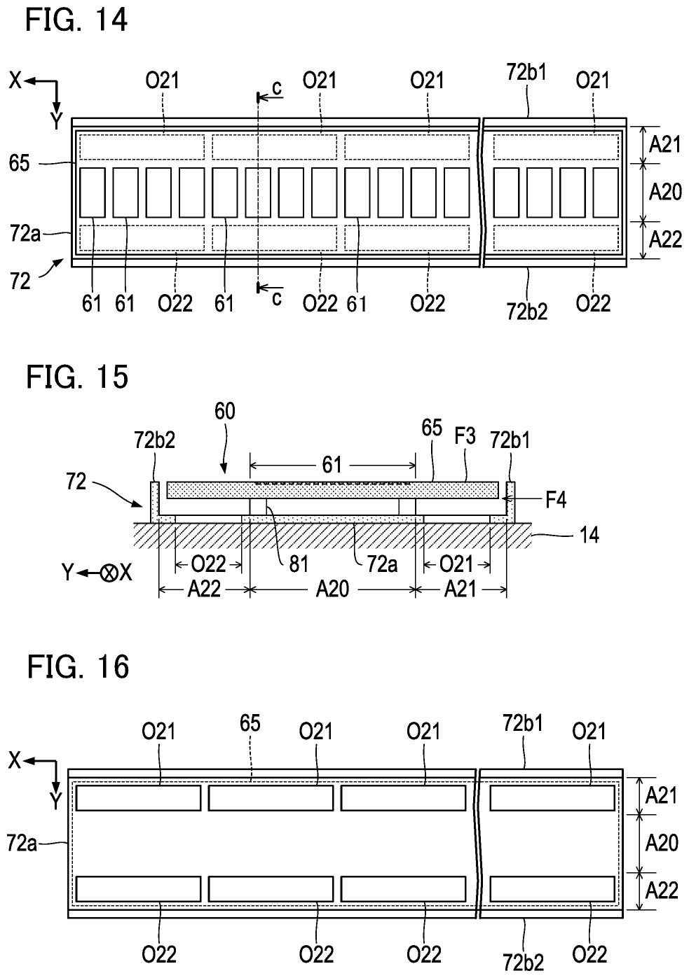

FIG. 14 is a plan view of the signal generators 60 according to the second embodiment. FIG. 15 is a cross section taken along line c-c in FIG. 14. FIG. 16 is a plan view of the second shield 72 according to the second embodiment. FIG. 16 shows a state in which the substructure 65 has been removed from FIG. 14.

The second base 72a of the second shield 72 includes a region A20, a region A21, and a region A22 in plan view. The region A21 is a band-shaped region extending in the direction of the X-axis along the second sidewall 72b1. The region A22 is a band-shaped region extending in the direction of the X-axis along the second sidewall 72b2. The region A20 is a band-shaped region extending in the direction of the X-axis between the region A21 and the region A22. As will be understood from FIGS. 14 and 15, the plurality of second coils 61 are aligned in the direction of the X-axis within a band-shaped region, which overlaps the region A20 in plan view, on the surface F3 of the substructure 65. No second coils 61 are formed in a region on the substructure 65 that overlaps the region A21, in addition to a region on the substructure 65 that overlaps the region A22.

As shown in FIGS. 14 to 16, a plurality of openings O2 (O21, O22) is formed on the second base 72a according to the second embodiment. Each opening O2 is a rectangular through hole penetrating the second base 72a.

A plurality of openings O21 is formed in the region A21 of the second base 72a. Specifically, the plurality of openings O21, which spaced apart from each other, is aligned in the direction of the X-axis within the region A21 in plan view. A plurality of openings O22 is formed in the region A22 of the second base 72a. Specifically, the plurality of openings O22, spaced apart from each other, is aligned in the direction of the X-axis within the region A22 in plan view. On the other hand, no openings O2 are formed in the region A20. In other words, each opening O2 according to the second embodiment does not overlap any of the plurality of second coils 61 in plan view.

The second embodiment realizes the same effects as in the first embodiment. In a configuration in which openings O2 are formed in the second shield 72 as in the second embodiment, the effects of the second shield 72 that prevents expansion of the magnetic field generated by the second coil 61 is reduced by the openings O2. Therefore, while a moderate effect of countermeasures against EMI by the second shield 72 is maintained, it is possible to generate a magnetic field over a wide area around the second coil 61. With expansion of range of the magnetic field generated by the second coil 61, a range of the position Z of the key 12, in which the magnetic field is changed, is expanded. In other words, it is easy to set a range in which the position Z of the key 12 is detectable.

The form (for example, planar shape, or the number) of the openings O2 in the second shield 72 may be freely selected. For example, in FIG. 16, a configuration is shown in which the plurality of openings O21 is aligned in the direction of the X-axis; however, a single opening O21 extending in the direction of the X-axis may be formed in the region A21. Similarly, instead of the plurality of openings O22 aligned in the direction of the X-axis, a single opening O22 extending in the direction of the X-axis may be formed in the region A22.

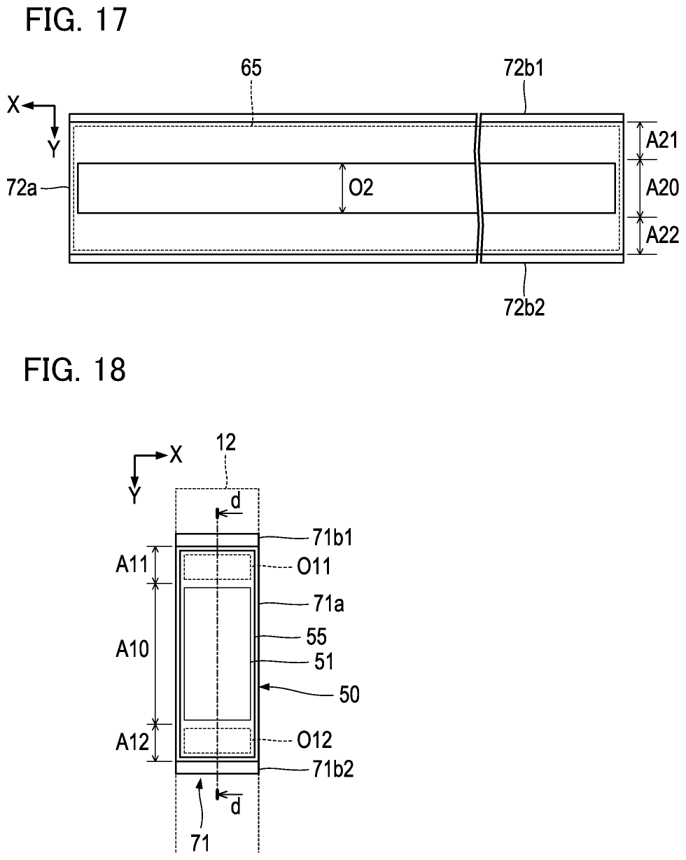

In the above description, the openings O2 are formed in each of the region A21 and the region A22 of the second base 72a; however, as shown in FIG. 17, an opening O2 may be formed in the region A20 of the second base 72a. In other words, the single opening O2 extending in the direction of the X-axis is formed in the region A20. The opening O2 overlaps the plurality of second coils 61 in plan view. In other words, the plurality of second coils 61 is positioned inside the opening O2 in plan view. Openings O2, which are spaced apart from each other and which are aligned in the direction of the X-axis, may be formed in the region A20.

### C: Third Embodiment

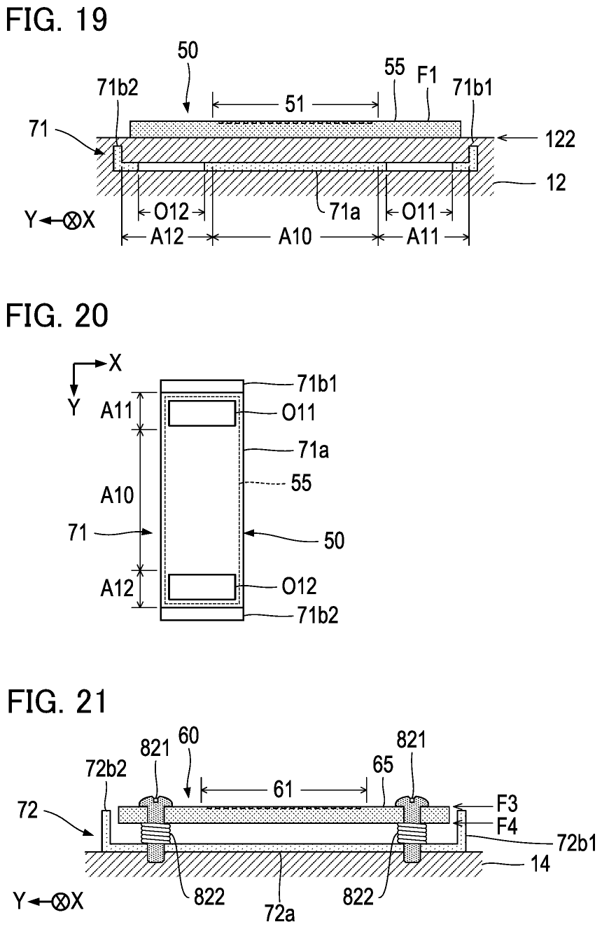

FIG. 18 is a plan view of the key 12 viewed from the signal generator 60. FIG. 19 is a cross section taken along line d-d in FIG. 18. FIG. 20 is a plan view of the first shield 71 according to a third embodiment. FIG. 20 shows a state in which the plurality of detectable portions 50 has been removed from FIG. 18.

The first base 71a of the first shield 71 includes a region A10, a region A11, and a region A12 in plan view. The region A11 is a region adjacent to the first sidewall 71b1. The region A12 is a region adjacent to the first sidewall 71b2. The region A10 is a region between the region A11 and the region A12. As will be understood from FIGS. 18 and 19, the first coil 51 is formed in a region, which overlaps the region A10 in plan view, on the surface F1 of the substructure 55. The first coil 51 is not formed in a region on the substructure 55, which overlaps the region A11, in addition to a region on the substructure 55 which overlaps the region A12.

As shown in FIGS. 18 to 20, a plurality of openings O1 (O11, O12) is formed in the first base 71a according to the third embodiment. Each opening O1 is a rectangular through hole penetrating the first base 71a.

The opening O11 is formed in the region A11 of the first base 71a. The opening O12 is formed in the region A12 of the first base 71a. On the other hand, the opening O1 is not formed in the region A10. In other words, each opening O1 according to the third embodiment does not overlap the first coil 51 in plan view.

The third embodiment realizes the same effects as in the first embodiment. In a configuration in which the openings O1 are formed in the first shield 71 as in the third embodiment, the effect of the first shield 71 of preventing expansion of the magnetic field generated by the first coil 51 is reduced by the openings O1. Therefore, although a moderate effect of countermeasures against EMI by the first shield 71 is maintained, the first coil 51 can generate a sufficient magnetic field. With expansion of range of the magnetic field generated by the first coil 51, a range of the position Z of the key 12, in which the magnetic field is changed, is expanded. In other words, it is easy to set a range in which the position Z of the key 12 is detectable.

A plurality of openings O1 may be formed in each of the region A11 and the region A12. One or more openings O1 overlapping the first coil 51 in plan view may be formed in the region A10. The openings O1 in the region A11 or the openings O1 in the region A12 may be omitted.

### D: Fourth Embodiment

FIG. 21 is a cross section of the signal generator 60 according to a fourth embodiment. Screws 821 in FIG. 21 are screws for fixing the substructure 65 and the second shield 72 to the support 14. The screws 821 are each inserted into the support 14 through both a through hole formed in the substructure 65 and a through hole formed in the second shield 72. Springs 822 are interposed between the substructure 65 and the second shield 72 (the second base 72a). The springs 822 are each a coil spring that surrounds the screw 821. The springs 822 urge the substructure 65 in a direction from the support 14 toward the substructure 65.

In the above configuration, a distance (gap) between the substructure 65 and the second shield 72 varies in accordance with degree of tightening of the screws 821. In other words, the screws 821 and the springs 822 function as an adjustor for adjusting the distance between the substructure 65 and the second shield 72. The magnetic field generated by the second coil 61 varies in accordance with the distance between the substructure 65 and the second shield 72. In response to adjusting the distance between the substructure 65 and the second shield 72, the distance between the first coil 51 and the second coil 61 is changed. In other words, the adjustor realized by the screws 821 and the springs 822 further functions as an element to adjust the distance between the first coil 51 and the second coil 61.

The fourth embodiment realizes the same effects as in the first embodiment. Furthermore, in the fourth embodiment, the magnetic field generated by the second coil 61 is adjusted by adjusting the distance between the substructure 65 and the second shield 72 using the adjustor (the screws 821 and the springs 822).

The configuration for adjusting the distance between the substructure 65 and the second shield 72 is not limited to the above example. For example, one fixing member 81 freely selected from among fixing members 81 having different lengths may be interposed between the substructure 65 and the second shield 72 to adjust the distance between the substructure 65 and the second shield 72. In other words, the fixing member 81 is used as an adjustor.

### E: Fifth Embodiment

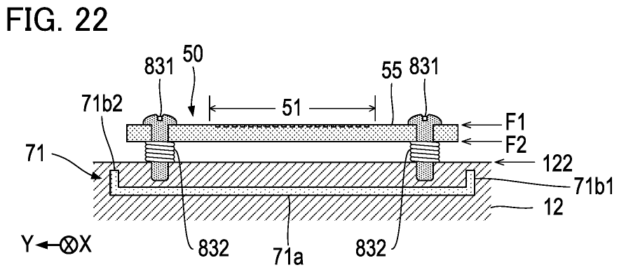

FIG. 22 is a cross section of the detectable portion 50 according to a fifth embodiment. The detectable portion 50 is disposed on the installation surface 122 of the key 12 by screws 831. Springs 832 are interposed between the surface F2 of the substructure 55 of the detectable portion 50 and the installation surface 122. The springs 832 are each, for example, a coil spring that surrounds the screw 831. The springs 832 urge the substructure 55 in a direction from the installation surface 122 toward the substructure 55.

In the above configuration, distance between the substructure 55 and the first shield 71 varies in accordance with degree of tightening of the screws 831. In other words, the screws 831 and the springs 832 function as an adjustor for adjusting the distance between the substructure 55 and the first shield 71. The magnetic field generated by the first coil 51 varies in accordance with the distance between the substructure 55 and the first shield 71. In response to adjusting the distance between the substructure 55 and the first shield 71, the distance between the first coil 51 and the second coil 61 is changed. In other words, the adjustor realized by the screws 831 and the springs 832 further functions as an element to adjust the distance between the first coil 51 and the second coil 61.

The fifth embodiment realizes the same effects as in the first embodiment. Furthermore, in the fifth embodiment, the magnetic field generated by the first coil 51 is adjusted by adjusting the distance between the substructure 55 and the first shield 71 using the adjustor (the screws 831 and the springs 832).

The configuration for adjusting the distance between the substructure 55 and the first shield 71 is not limited to the above example. For example, one fixing member freely selected from among fixing members having different lengths may be interposed between the substructure 55 and the first shield 71 to adjust the distance between the substructure 55 and the first shield 71.

### F: Sixth Embodiment

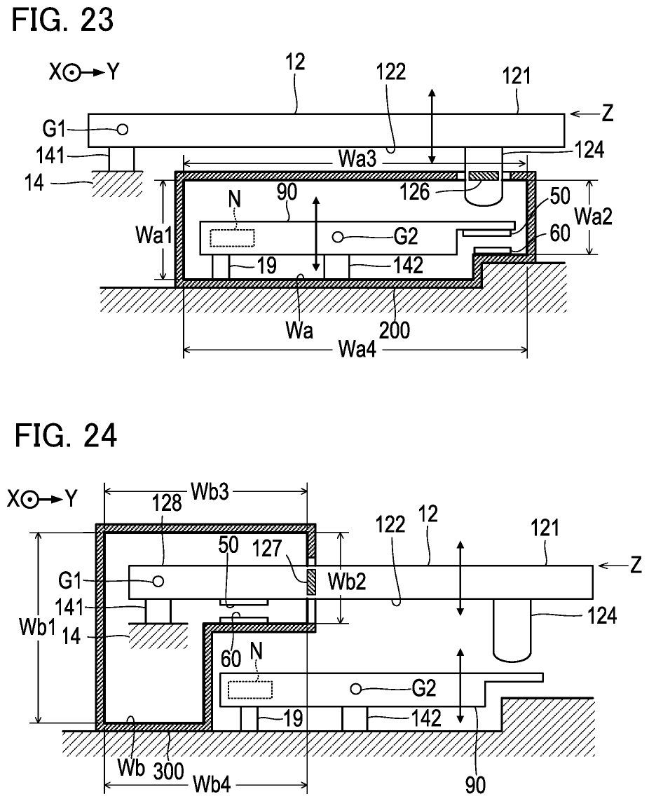

FIG. 23 is a schematic diagram of the detection system 20 according to a sixth embodiment. As in the first embodiment, the detection system 20 generates, for each of the plurality of keys 12, the detection signal D having a level depending on the position Z of the end 121 in the vertical direction.

Each key 12 is supported by the support 14 using a fulcrum body G1 as a fulcrum. The fulcrum body G1 is disposed on the support 14 via a support fulcrum body 141 disposed on the support 14. In other words, the key 12 is supported by the support 14 via the fulcrum body G1 and the support fulcrum body 141. The key 12 rotates around the fulcrum body G1.

The key 12 according to the sixth embodiment includes a protrusion 124. The protrusion 124 is a portion protruding from the installation surface 122 included in the end 121. The protrusion 124 is displaced in the vertical direction in response to each of depression and release of the key by a user. A tip of the protrusion 124 includes a curved surface.

The musical keyboard instrument 100 according to the sixth embodiment includes a housing 200 and an urging body 90. The housing 200 is a hollow structure. The housing 200 is disposed on the support 14. The protrusion 124 passes through an opening formed in the housing 200. The urging body 90 is a structure for providing a user with a feeling corresponding to depression of keys. The urging body 90 is disposed for each of the plurality of keys 12. A plurality of urging bodies 90 is housed inside the housing 200. Specifically, the urging body 90 is supported by the support 14 using a fulcrum body G2 as a fulcrum. The fulcrum body G2 is disposed in the housing 200 via a fulcrum support 142 disposed in an inner space of the housing 200. In other words, the urging body 90 is supported by the support 14 via the fulcrum body G2, the fulcrum support 142, and the housing 200.

When the urging body 90 is not depressed, the urging body 90 is in contact with a stopper 19 positioned in the inner space of the housing 200. When the tip of the protrusion 124 presses down on the urging body 90 in response to depression of the key, the urging body 90 moves away from the stopper 19 to rotate around the fulcrum body G2. A weight N for pressing a first end of the urging body 90 opposite to a second end of the urging body 90, on which the detectable portion 50 is disposed, is disposed inside the first end. Therefore, when the urging body 90 is depressed by the protrusion 124, a moderate feeling of resistance is provided to the user. In other words, a good operating feeling can be given to a player.

The detectable portion 50 is disposed on the urging body 90. For example, the detectable portion 50 is disposed on the surface of the urging body 90 that is opposite to a surface of the urging body 90 facing the protrusion 124. In the sixth embodiment, the detectable portion 50 is disposed on a portion overlapping the protrusion 124 in plan view. The portion of the urging body 90, on which the detectable portion 50 is disposed, may be freely selected. For example, the detectable portion 50 may be disposed on the surface of the urging body 90 on which the protrusion 124 is disposed. On the other hand, the signal generator 60 is disposed on an inner wall surface Wa of the housing 200. The second coil 61 of the signal generator 60 is disposed to overlap the first coil 51 of the detectable portion 50 in plan view.

The urging body 90 on which the first coil 51 is disposed is displaceable by depression of the key. Therefore, as in the first embodiment, the detection system 20 generates the detection signal D having a level depending on the distance between the first coil 51 and the second coil 61.

The inner wall surface Wa of the housing 200 is formed of a magnetic or a conductive material. The inner wall surface Wa of the housing 200 surrounds the first coil 51 and the second coil 61. In other words, the inner wall surface Wa of the housing 200 functions as an electromagnetic shield that blocks the electromagnetic waves emitted from the detection system 20. The inner wall surface Wa (that is, the electromagnetic shield) according to the sixth embodiment includes a first portion Wa1, a second portion Wa2, a third portion Wa3, and a fourth portion Wa4.

The first portion Wa1 is a portion positioned apart from both the first coil 51 and the second coil 61 in the negative direction of the Y-axis (an example of a “first direction”). The second portion Wa2 is a portion positioned apart from both the first coil 51 and the second coil 61 in the positive direction of the Y-axis (an example of a “second direction”). The third portion Wa3 is a portion positioned above both the first coil 51 and the second coil 61. The fourth portion Wa4 is a portion positioned below both the first coil 51 and the second coil 61. A shield 126, which functions as an electromagnetic shield, may be embedded in a portion of the protrusion 124 corresponding to the opening of the housing 200. The shield 126 is formed of magnetic or conductive material. The shield 126 (an example of a “third portion”) is positioned above both the first coil 51 and the second coil 61.

In the sixth embodiment, since the inner wall surface Wa, which functions as an electromagnetic shield, surrounds the first coil 51 and the second coil 61, effective countermeasures against EMI are realized.

### G: Seventh Embodiment

FIG. 24 is a schematic diagram of the detection system 20 according to a seventh embodiment. In the seventh embodiment, the positions of the detectable portion 50 and the signal generator 60 are different from those of the sixth embodiment.

The musical keyboard instrument 100 according to the seventh embodiment includes a housing 300 instead of the housing 200. The housing 300 is a hollow structure. The housing 300 is disposed on the support 14. The single housing 300 is disposed for the plurality of keys 12. An end 128 of each key 12 (an end supported by the support 14) opposite to the end 121 is housed in an inner space of the housing 300. Each key 12 passes through a through hole in the housing 300.

The detectable portion 50 according to the seventh embodiment is disposed on the installation surface 122 in the inner space of the housing 300. The signal generator 60 is disposed on a portion of the inner wall surface Wb facing the detectable portion 50. In other words, the inner wall surface Wb of the housing 300 surrounds the first coil 51 and the second coil 61.

The inner wall surface Wb of the housing 300 is formed of a magnetic or a conductive material. The inner wall surface Wb of the housing 300 surrounds the first coil 51 and the second coil 61. In other words, the inner wall surface Wb of the housing 300 functions as an electromagnetic shield that blocks electromagnetic waves emitted from the detection system 20. The inner wall surface Wb (that is, an electromagnetic shield) according to the seventh embodiment includes a first portion Wb1, a second portion Wb2, a third portion Wb3, and a fourth portion Wb4.

The first portion Wb1 is a portion positioned apart from both the first coil 51 and the second coil 61 in the negative direction of the Y-axis. The second portion Wb2 is a portion positioned apart from both the first coil 51 and the second coil 61 in the positive direction of the Y-axis. The third portion Wb3 is a portion positioned above both the first coil 51 and the second coil 61. The fourth portion Wb4 is a portion positioned below both the first coil 51 and the second coil 61. A shield 127, which functions as an electromagnetic shield, may be embedded in a portion of the key 12 corresponding to the opening of the housing 300. For example, the shield 127 may be formed of magnetic or conductive material. The shield 127 (an example of a “second portion”) is positioned apart from both the first coil 51 and the second coil 61 in the positive direction of the Y-axis.

In the seventh embodiment, as in the sixth embodiment, since the inner wall surface Wb, which functions as an electromagnetic shield, surrounds the first coil 51 and the second coil 61, effective countermeasures against EMI are realized. For example, in a configuration in which the housing 300 in FIG. 24 is omitted, when the weight N formed of a magnetic body, such as one of metal, is moved up and down in conjunction with the key 12, the magnetic field around the detectable portion 50 or the magnetic field around the signal generator 60 is affected. In the seventh embodiment, since a portion of the housing 300 is interposed between the weight N and the detection system 20 (the detectable portion 50 and the signal generator 60), the effect of the weight N on the detection system 20 is reduced. In other words, it is possible to reduce the effects of an element (for example, the weight N) in a vicinity of the detection system 20 on the magnetic field for detecting the position Z. Therefore, there is an advantage of being able to detect the position Z of each key 12 with high accuracy. In the seventh embodiment, the urging body 90 may be omitted.

### H: Eighth Embodiment

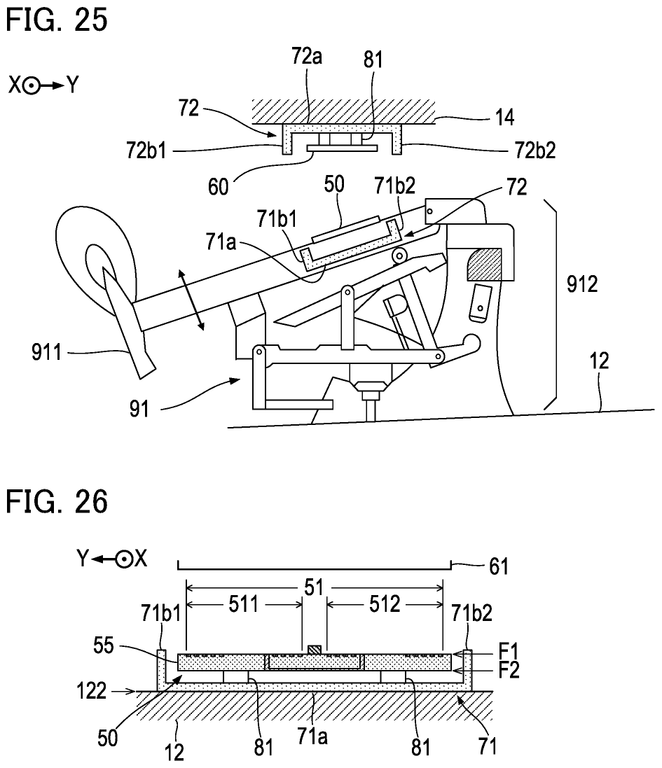

In an eighth embodiment, a configuration will be described in which the detection system 20 is applied to a strike mechanism 91 of the musical keyboard instrument 100. FIG. 25 is a schematic view of a configuration of the detection system 20 according to the eighth embodiment. As in a piano, which is an acoustical musical instrument, the strike mechanism 91 is a mechanism that strikes a string (not shown) in conjunction with a displacement of each key 12 in the keyboard 10. Specifically, the strike mechanism 91 includes, for each key 12, a hammer 911 capable of striking a string by rotation and a transmission mechanism 912 (for example, a whippen, jack, repetition lever, etc.) that causes the hammer 911 to rotate in conjunction with the displacement of the key 12. By the above configuration, the detection system 20 detects displacement of the hammer 911 (an example of a “movable member”).

The detectable portion 50 according to the eighth embodiment is disposed on the hammer 911 (for example, hammer shank). The first shield 71 according to the eighth embodiment is embedded in the hammer 911. As in the first embodiment, the first shield 71 includes the first base 71a, the first sidewall 71b1, and the first sidewall 71b2. The first shield 71 is disposed at a position overlapping the first coil 51 in plan view.

As in the first embodiment, the signal generator 60 is disposed on the support 14. The support 14 according to the eighth embodiment is, for example, a structure supporting the strike mechanism 91. The detectable portion 50 may be disposed on a member other than the hammer 911 in the strike mechanism 91. As in the first embodiment, the second shield 72 includes the second base 72a, the second sidewall 72b1, and the second sidewall 72b2. As in the first embodiment, the signal generator 60 is supported by the second shield 72 (the second base 72a), which is disposed on the surface of the support 14, via the fixing members 81. The eighth embodiment realizes the same effects as in the first embodiment. The configurations of the second to sixth embodiments are applicable to the eighth embodiment.

### I: Modifications

Specific modifications added to each of the aspects described above are described below. Two or more modes selected from the following descriptions may be combined with one another as appropriate as long as such combination does not cause any conflicts.

(1) In each of the above embodiments, the key 12 and the urging body 90 are each described as a movable member; however, the movable member is not limited to the key 12 or the urging body 90. The movable member may be freely selected as long as the movable member is displaceable in response to playing operation. For example, the detection system 20 may be applied to a pedal mechanism of the musical keyboard instrument 100. The pedal mechanism includes a pedal operated by a user's foot and the support 14 supporting the pedal. By the above configuration, the detection system 20 detects the displacement of the pedal. For example, the detectable portion 50 is disposed on the pedal, and the signal generator 60 is disposed on the support 14 such that the signal generator 60 faces the detectable portion 50. The pedal is an example of a movable member.

As will be understood from the above description, a target of detection by the detection system 20 is represented as a movable member that is displaceable in response to a playing operation. The movable member includes, in addition to a playing operator, such as the key 12 and the pedal, which is directly operated by a user, a structure such as the hammer 911 that is displaced in conjunction with an operation to the playing operator. However, the movable member according to the present disclosure is not limited to a member that is displaceable in response to a playing operation. In other words, the movable member is represented as a displaceable member regardless of how displacement takes place.

(2) In each of the above embodiments, as long as the detectable portion 50 is disposed on the movable member in a situation in which the signal generator 60 is disposed to face the detectable portion 50, the installation positions of the detectable portion 50 and the signal generator 60 may be freely selected.

(3) In the first and eighth embodiments, the first shield 71 includes the first base 71a, the first sidewall 71b1, and the first sidewall 71b2; however, the configuration of the first shield 71 is not limited to the above examples. For example, a configuration, in which the first shield 71 includes either the first base 71a or the first sidewall 71b (71b1, 71b2), or a configuration in which the first shield 71 includes a portion different from both the first base 71a and the first sidewall 71b (71b1, 71b2) may be used. The first shield 71 may include a first sidewall protruding from a peripheral edge along the X-axis among peripheral edges of the first base 71a toward the support 14. As will be understood from the above description, the form of the first shield 71 may be freely selected.

(4) In the first and eighth embodiments, the second shield 72 includes the second base 72a, the second sidewall 72b1, and the second sidewall part 72b2; however, a configuration of the second shield 72 is not limited to the above examples. For example, a configuration, in which the second shield 72 includes either the second base 72a or the second sidewall 72b (72b1, 72b2), or a configuration in which the second shield 72 includes a portion different from both the second base 72a and the second sidewall 72b (72b1, 72b2) may be used. The second shield 72 may include a second sidewall protruding from a peripheral edge along the X-axis among peripheral edges of the second base 72a toward the movable member. As will be understood from the above description, the form of the second shield 72 may be freely selected.

(5) In the first and eighth embodiments, the electromagnetic shield 70 includes the first shield 71 and the second shield 72; however, a configuration of the electromagnetic shield 70 is not limited to the above examples. For example, a configuration, in which the electromagnetic shield 70 includes either the first shield 71 or the second shield 72, or a configuration in which the electromagnetic shield 70 includes a portion different from both the first shield 71 and the second shield 72, may be used.

(6) In the first embodiment, the entire first shield 71 is embedded in the key 12; however, at least a part of the first shield 71 may be embedded in the movable member. Furthermore, the first shield 71 need not be embedded in the key 12. As shown in FIG. 26, for example, the detectable portion 50 may be disposed on a surface of the first shield 71, which is disposed on a surface of the key 12, via the fixing members 81 formed of insulating material. In the eighth embodiment, the entire first shield 71 need not be embedded in the hammer 911.

(7) In the first embodiment, the second shield 72 is disposed on the surface of the support 14; however, the second shield 72 may be embedded in the support 14. In the above configuration, for example, the signal generator 60 is disposed on a portion of the surface of the support 14 that overlaps the second shield 72 in plan view.

(8) In the first and eighth embodiments, a second shield 72 may be disposed for each key 12.

(9) In the sixth embodiment, the entire housing 200 may be formed of a magnetic or a conductive material. In other words, the entire housing 200 functions as an electromagnetic shield for blocking electromagnetic waves emitted from the detection system 20. Similarly, in the seventh embodiment, the entire housing 300 may be formed of a magnetic or a conductive material.

(10) In the sixth and seventh embodiments, the inner wall surface (Wa or Wb) of the housing (200 or 300) is used as an electromagnetic shield; however, the housing may not be used as an electromagnetic shield. In other words, a member different from the housing may be used as an electromagnetic shield. The portion of the electromagnetic shield, which is positioned apart from both the first coil 51 and the second coil 61 in the negative direction of the Y-axis, is represented as a first portion, and the portion of the electromagnetic shield, which is positioned apart from both the first coil 51 and the second coil 61 in the positive direction of the Y-axis, is represented as a second portion. The portion of the electromagnetic shield, which is positioned above both the first coil 51 and the second coil 61, is represented as a third portion, and the portion of the electromagnetic shield, which is positioned below both the first coil 51 and the second coil 61, is represented as a fourth portion. The first shield 71 may be an example of the third portion, and the second shield 72 may be an example of the fourth portion. The electromagnetic shield may include at least one of the first portion, the second portion, the third portion, and the fourth portion, or the electromagnetic shield may include a portion different from any of the first portion, the second portion, the third portion, and the fourth portion.

(11) In the sixth embodiment, the housing 200 may be disposed for each urging body 90. Similarly, in the seventh embodiment, the housing 300 may be disposed for each key 12.

(12) In each of the above embodiments, there is shown a configuration in which the musical keyboard instrument 100 has the sound source circuit 34; however, the sound source circuit 34 may be omitted in a configuration in which the musical keyboard instrument 100 includes a sound producing mechanism such as the strike mechanism 91, for example. The detection system 20 is used to record how the musical keyboard instrument 100 is played. The sound producing mechanism and the sound source circuit 34 are represented as a sound generator that generates sound in accordance with a result of detection by the detection system 20.

As will be understood from the above description, the present disclosure may be understood as an apparatus for playing an instrument (musical instrument playing apparatus) that controls a musical sound by providing the sound source circuit 34 or the sound producing mechanism with an operation signal in accordance with a playing operation. The concept of the musical instrument playing apparatus includes not only an instrument (the musical keyboard instrument 100) provided with the sound source circuit 34 or the sound producing mechanism as described in each of the above embodiments, but also a device (for example, a MIDI controller or the pedal mechanism as described above) not provided with the sound source circuit 34 or a sound producing mechanism. That is, the musical instrument playing apparatus according to the present disclosure is represented as an apparatus operated by a player (or an operator) of an instrument to play an instrument.

(13) In each of the above embodiments, there is shown a configuration in which the first coil 51 includes the first section 511 and the second section 512; however, the first coil 51 need not be constituted of two coils. The first coil 51 may include only a single coil (for example, either the first section 511 or the second section 512). Similarly, the second coil 61 need not be constituted of two coils (third section 611 and fourth section 612).

(14) In each of the above embodiments, the detectable portion 50 may include, for example, a metal plate, etc., instead of the first coil 51. The detectable portion 50 may include a magnetic body that generates an induced current based on electromagnetic induction due to the magnetic field generated by the second coil 61. The first coil 51 is an example of a magnetic body.

### J: Supplemental Notes

The following configurations are derivable from the different embodiments described above.

A musical instrument playing apparatus according to one aspect (first aspect) of the present disclosure includes a movable member that is displaceable in response to a playing operation, a detection system including a magnetic body and a coil facing the magnetic body, the magnetic body being disposed on the movable member, the coil being configured to generate a magnetic field in response to supply of current, the detection system being configured to generate a detection signal having a level depending on a distance between the magnetic body and the coil, and an electromagnetic shield for blocking electromagnetic waves emitted from the detection system. According to the aspect described above, countermeasures against EMI are realized by the electromagnetic shield for blocking the electromagnetic waves emitted from the detection system including the magnetic body and the coil. Therefore, it is possible to reduce the effects of electromagnetic waves emitted from the detection system on surrounding electronic devices. In addition, it is possible to reduce the effects of an element positioned in a vicinity of the detection system on a magnetic field around the coil.

In an example (second aspect) of the first aspect, the musical instrument playing apparatus further includes a support supporting the movable member, the electromagnetic shield includes a first shield disposed on the movable member, and a second shield disposed on the support. According to the aspect described above, since the electromagnetic shield includes the first shield disposed on the movable member and the second shield disposed on the support, effective countermeasures against EMI are realized compared to a configuration in which an electromagnetic shield is disposed on either the support or the movable member.

In an example (third aspect) of the second aspect, the first shield includes a first base, and the coil is positioned between the magnetic body and the first base. According to the aspect described above, since the coil is positioned between the magnetic body and the first base, the first shield can effectively block the electromagnetic waves emitted from the magnetic body in a direction opposite to a direction from the magnetic body toward the coil.

In an example (fourth aspect) of the third aspect, the movable member faces the support, and the first shield includes a first sidewall protruding from the first base toward the support. According to the aspect described above, since the first shield includes the first sidewall, there is an advantage of effectively blocking electromagnetic waves emitted from the magnetic body toward the surroundings.

In an example (fifth aspect) of any one of the second to the fourth aspects, at least a part of the first shield is embedded in the movable member. According to the aspect described above, since at least a part of the first shield is embedded in the movable member, countermeasures against EMI are realized without drastically changing the original form of the movable member.

In an example (sixth aspect) of the second aspect, the second shield includes a second base, and the coil is positioned between the magnetic body and the second base. According to the aspect described above, since the coil is positioned between the magnetic body and the second base, the second shield can effectively block the electromagnetic waves emitted from the coil in a direction opposite to a direction from the coil toward the magnetic body.

In an example (seventh aspect) of the sixth aspect, the movable member faces the support, and the second shield includes a second sidewall protruding from the second base toward the movable member. According to the aspect described above, since the second shield includes the second sidewall, there is an advantage of effectively blocking electromagnetic waves emitted from the coil toward the surroundings.

A musical instrument playing apparatus according to an example (eighth aspect) of any one of the second to the seventh aspects further includes a substructure on which the coil is disposed, and an adjustor configured to adjust a distance between the substructure and the second shield. According to the aspect described above, it is possible to change the magnetic field generated by the coil in accordance with adjustments to the distance between the second shield and the substructure.

In an example (ninth aspect) of the first aspect, the electromagnetic shield surrounds the magnetic body and the coil. According to the aspect described above, since the electromagnetic shield surrounds the magnetic body and the coil, effective countermeasures against EMI are realized.

In an example (tenth aspect) of the ninth aspect, the movable member is an elongated key constituting a keyboard of a musical keyboard instrument, the electromagnetic shield includes a first portion positioned apart from both the magnetic body and the coil in a first direction along a longitudinal direction of the key, a second portion positioned apart from both the magnetic body and the coil in a second direction opposite to the first direction, a third portion positioned above both the magnetic body and the coil, and a fourth portion positioned below both the magnetic body and the coil. According to the aspect described above, since the electromagnetic shield surrounds both the magnetic body and the coil, effective countermeasures against EMI are realized.

A musical keyboard instrument according to another aspect (eleventh aspect) of the present disclosure includes a key that is displaceable in response to a playing operation, a detection system including a magnetic body and a coil facing the magnetic body, the magnetic body being disposed on the key, the coil being configured to generate a magnetic field in response to supply of current, the detection system being configured to generate a detection signal having a level depending on a distance between the magnetic body and the coil, an electromagnetic shield for blocking electromagnetic waves emitted from the detection system, and a sound generator configured to generate a sound in accordance with the detection signal.

### DESCRIPTION OF REFERENCE SIGNS

100 . . . musical keyboard instrument (musical instrument playing apparatus), 10 . . . keyboard, 12 . . . key, 122 . . . installation surface, 124 . . . protrusion, 126, 127 . . . shield, 14 . . . support, 19 . . . stopper, 20 . . . detection system, 200 . . . housing, 21 . . . signal processing circuit, 22 . . . supply circuit, 23 . . . output circuit, 30 . . . information processing apparatus, 300 . . . housing, 31 . . . controller, 32 . . . storage device, 33 . . . converter, 34 . . . sound source circuit, 40 . . . sound output device, 50 . . . detectable portion, 51 . . . first coil, 511 . . . first section, 512 . . . second section, 514 . . . connecting wiring, 52 . . . capacitive element, 55 . . . substructure, 60 . . . signal generator, 61 . . . second coil, 611 . . . third section, 612 . . . fourth section, 614 . . . connecting wiring, 62, 63 . . . capacitive element, 65 . . . substructure, 70 . . . electromagnetic shield, 71 . . . first shield, 71a . . . first base, 71b1, 71b2 . . . first sidewall, 72 . . . second shield, 72a . . . second base, 72b1, 72b2 . . . second sidewall, 81 . . . fixing member, 90 . . . urging body, 91 . . . strike mechanism, 911 . . . hammer, 912 . . . transmission mechanism, T1 . . . input terminal, T2 . . . output terminal, Wa . . . inner wall surface, Wa1 . . . first portion, Wa2 . . . second portion, Wa3 . . . third portion, Wa4 . . . fourth portion, Wb . . . inner wall surface, Wb1 . . . first portion, Wb2 . . . second portion, Wb3 . . . third portion, Wb4 . . . fourth portion, G1, G2 . . . fulcrum body, 141, 142 . . . fulcrum support.

What is claimed is:

1. A musical instrument playing apparatus comprising:
a movable member displaceable in response to a playing operation;
a detection system including:
a magnetic body disposed on or in the movable member; and
a coil facing and spaced from the magnetic body and configured to generate a magnetic field in response to receiving a supply of current,
wherein the detection system is configured to generate a detection signal with a level that depends on a distance between the magnetic body and the coil; and
an electromagnetic shield configured to block electromagnetic waves emitted from the detection system.

2. The musical instrument playing apparatus according to claim 1, further comprising:
a support supporting the movable member,
wherein the electromagnetic shield includes:
a first shield disposed on or in the movable member, and
a second shield disposed on the support.

3. The musical instrument playing apparatus according to claim 2, wherein:
the first shield includes a first base, and
the coil is positioned between the magnetic body and the first base.

4. The musical instrument playing apparatus according to claim 3, wherein:
the movable member faces the support, and
the first shield includes a first sidewall protruding from the first base toward the support.

5. The musical instrument playing apparatus according to claim 2, wherein at least part of the first shield is embedded in the movable member.

6. The musical instrument playing apparatus according to claim 2, wherein:
the second shield includes a second base, and
the coil is positioned between the magnetic body and the second base.

7. The musical instrument playing apparatus according to claim 6, wherein:
the movable member faces the support, and
the second shield includes a second sidewall protruding from the second base toward the movable member.

8. The musical instrument playing apparatus according to claim 2, further comprising:
a substructure on which the coil is disposed, and
an adjustor configured to adjust a distance between the substructure and the second shield.

9. The musical instrument playing apparatus according to claim 1, wherein the electromagnetic shield surrounds the magnetic body and the coil.

10. The musical instrument playing apparatus according to claim 9, wherein:
the movable member is an elongated key constituting a keyboard of a musical keyboard instrument,
the electromagnetic shield includes:
a first portion positioned spaced from both the magnetic body and the coil in a first direction along a longitudinal direction of the key,
a second portion positioned spaced from both the magnetic body and the coil in a second direction opposite to the first direction,
a third portion positioned above both the magnetic body and the coil, and
a fourth portion positioned below both the magnetic body and the coil.

11. A musical keyboard instrument comprising:
a key displaceable in response to a playing operation;
a detection system including:
a magnetic body disposed on or in the key; and
a coil facing and spaced from the magnetic body and configured to generate a magnetic field in response to receiving a supply of current,
wherein the detection system is configured to generate a detection signal with a level that depends on a distance between the magnetic body and the coil;
an electromagnetic shield configured to block electromagnetic waves emitted from the detection system; and
a sound generator configured to generate sound in accordance with the detection signal.
